(19) United States
(12) Patent Application Publication
(10) Pub. No.: US 2013/0110633 A1
(43) Pub. Date: May 2, 2013

(54) ADAPTIVE PRESENTATION OF GUIDED TOUR INFORMATION ON MOBILE CLIENT TERMINAL(S)

(71) Applicant: Digital Footsteps, Ltd., Gush Etzion (IL)

(72) Inventors: Julie WALDMAN, Gush Etzion (IL); Ehud SPIEGEL, Petach-Tikva (IL); Harry FOX, Jerusalem (IL)

(73) Assignee: Digital Footsteps, Ltd., Gush Etzion (IL)

(21) Appl. No.: 13/665,961

(22) Filed: Nov. 1, 2012

Related U.S. Application Data
(60) Provisional application No. 61/554,534, filed on Nov. 2, 2011.

(51) Int. Cl. G01C 21/00; G06Q 30/02

(52) U.S. Cl. 705/14.58; 701/526; 701/428; 701/522; 701/466

(57) ABSTRACT

A method of adaptive generating of navigation instructions on a mobile client terminal. The method comprises acquiring, using a mobile client terminal, at least one path passing via a plurality of points of interest and guided tour information pertaining to a tour along the at least one path, monitoring a power availability and a current location of the mobile client terminal, presenting navigation instructions to a user of the mobile client terminal according to the current location in relation to the at least one path, presenting the guided tour information to the user according to the current location, and updating at least one of the navigation instructions and a presentation of the guided tour information according to the power availability.

### RELATED APPLICATION

This application claims the benefit of priority under 35 USC §119(e) of U.S. Provisional Patent Application No. 61/554,534 filed Nov. 2, 2011, the contents of which are incorporated herein by reference in their entirety.

### FIELD AND BACKGROUND OF THE INVENTION

The present invention, in some embodiments thereof, relates to guided tours and, more particularly, but not exclusively, to methods and systems of adaptive generating of navigation instructions on mobile client terminal(s).

During the last years, business, local and international tourism has become one of the most thriving markets. World travel market reached 930 million tourists crossing between nations in 2007, according to the world tourism organization (WTO) reports. This market growth may be reflected by the booming internet tourism activity with more than 250 million unique monthly travel web site visitors.

Tour-guide systems are known. In the simplest form, a self-guided tour system may include signposts and marked walking paths. The user follows the marks that indicate the route to each exhibit and reads the signs or displays that provide information about the historical and cultural significance of each exhibit. Outdoor self guided tour systems may include walking paths formed by dots or lines of bricks imbedded in the sidewalks, or markers on trees and buildings, which lead users to points of interest. Points of interest, as used herein, can mean anything of interest to a user, ranging from a building, a machine, a work of art or an artifact, to a living thing, or just a site having historical, cultural, entertainment, economical or educational significance.

Some points of interest, in addition to displays containing text and graphics, are known to include audio programming devices that provide speech, music and sound effects relating to the exhibit. Self-guided tours with portable information devices are known. For example, art museum systems have been known to include a portable device that plays audio information about each exhibit. The user enters the number of the exhibit into the portable player, which responds by playing pre-recorded information regarding the exhibit. Such systems typically store the recorded information in a programmed memory chip. Guided tours by audio tape recorder are also known. The user inserts a recording medium into the player, and follows the instructions given. The user receives information about each exhibit, and directions to find the next exhibit on the tour. The tour-guide recording medium may include sound effects and music in addition to spoken material to effectively recreate historical-context or information of interest relating to each exhibit.

Self-guided tour systems using the Global Positioning Satellite (GPS) system have been proposed. For example, U.S. Pat. No. 5,767,795 to Shaphorst shows an electronic tour-guide system using a GPS receiver and a local data storage device, such as a CD-ROM. The GPS receiver determines the instantaneous geographic location, and the CD ROM player provides audio or video information on the history, geography, and culture associated with the geographic region including comments about a specific point of interest. Another example is described in U.S. Pat. No. 7,463,977 to Price which describes a system for providing a tour of a venue includes a central computer for creating the tour, at least one venue server computer, communicatively connected to the central computer remotely at the venue, for storing the tour, and at least one portable device, communicatively connected to the venue server computer at the venue, for obtaining the tour from the venue server computer. The at least one portable device includes a GPS receiver or other geographic location identifier. Particular “point of interest”-specific content of the tour is output by the portable device whenever the device is located at the geographical location of the coordinates for the point of interest. The specific content of the tour so output by the portable device includes multimedia, including, for example, text, graphics, audio, video, and others. The portable device is carried by a tourist or other user and provides interactive multimedia to guide during the tour. Tours are created and edited at the central computer, and then communicated to the venue server computer. The venue server computer is located at or near the venue of the tour, and thereat writes the relevant tour or tours to the portable device. The venue server computer includes security, control and payment systems for access to use the portable device. The portable device logs usage information for the device, and this information is communicated back to the venue server computer and on to the central computer.

### SUMMARY OF THE INVENTION

According to some embodiments of the present invention, there is provided a method of adaptive generating of navigation instructions on a mobile client terminal. The method comprises acquiring, using a mobile client terminal, at least one path passing via a plurality of points of interest and guided tour information pertaining to a tour along the at least one path, monitoring power availability and a current location of the mobile client terminal, presenting navigation instructions to a user of the mobile client terminal according to the current location in relation to the at least one path, presenting the guided tour information to the user according to the current location, and updating at least one of the navigation instructions and a presentation of the guided tour information according to the power availability.

Optionally, the navigation instructions allows instructing the user along the at least one path without requiring a data connection with a remote server.

Optionally, the updating comprises calculating, locally on the mobile client terminal, a new path passing via at least one of the plurality of points of interest so that the power availability is sufficient for presenting a portion of the guided tour information pertaining to the at least one point of interest, and presenting navigation instructions to a user using the mobile client terminal according to the new path.

Optionally, the acquiring comprises acquiring a plurality of map segments enclosing and depicting the at least one path; wherein the presenting navigation instructions comprises presenting at least part of at least one of the plurality of map segments to the user of the mobile client terminal according to the current location in relation to the at least one path.

Optionally, the acquiring comprises acquiring from the user at least one of the plurality of points of interest and sending the at least one user selected point of interest to a network node via a network to allow the network node to calculate the at least one path.

More optionally, the network node adds at least one new point of interest to the plurality of points of interest, the at least one new point being selected according to at least one tour conducted by another user.

More optionally, the user and the additional user are socially connected to one another.

More optionally, the network node adds at least one new point of interest to the plurality of points of interest according to social media data pertaining to at least one additional user which is socially connected to the user.

Optionally, the at least one path is calculated to pass in an area covered by at least one access point; further comprising instructing the mobile client terminal to automatically establish a wireless connection with the at least one access point to at least one of download an update to the at least one path, download an update to the guided tour information, and to upload data acquired during the presenting.

Optionally, the acquiring comprises acquiring at least one advertisement having a location tag; further comprising presenting the at least one advertisement according to a match between the current location and the location tag.

More optionally, the advertisement is a location based coupon selected according to the current location.

Optionally, the method further comprises presenting guided tour information pertaining to some of the plurality of points of interest only when the current location is in proximity thereto.

Optionally, the presenting the guided tour information comprises presenting a purchase offer according to the current location and suspending the presentation of the guided tour information until the user approves the purchase offer.

More optionally, the method further comprises providing at least one of preferences and characteristics of the user; wherein the network node adds at least one new point of interest to the plurality of points of interest according to at least one of the preferences and the characteristics.

Optionally, the method further comprises recording the location as long as the user perform the tour so as to create a tour log and sharing the tour log with a plurality of other users.

Optionally, the method further comprises controlling at least one hardware component of the mobile client terminal according to the power availability.

Optionally, acquiring comprises acquiring a plurality of access point locations in proximity to the at least one path; further comprising adjusting the navigation instructions to instruct a user to pass via one of the plurality of access point locations.

Optionally, the method further comprises billing the user for at least some of the guided tour information.

Optionally, the updating comprises setting instructing another mobile client terminal to perform the presentation.

Optionally, the updating comprises setting instructing to another mobile client terminal to perform the presentation.

According to some embodiments of the present invention, there is provided a method of splitting a tour managed by a mobile client terminal. The method comprises providing a plurality of preferences each of another of a plurality of tour participants, uploading to a mobile client terminal guided tour information pertaining to a plurality at points of interest in a tour navigated using the mobile client terminal, monitoring a current location of the mobile client terminal, calculating a plurality of navigation instructions sets each for another of a plurality of sub tours, each the sub tour passes via another of the plurality at points of interest, the another point of interest being selected according to respective the preferences of one of the plurality of tour participants and a proximity to the current location, and outputting the plurality of navigation instructions sets.

Optionally, at least one of the navigation instructions sets is forwarded to another mobile client terminal.

According to some embodiments of the present invention, there is provided a method of sharing the display of guided tour information. The method comprises installing on a plurality of mobile client terminals guided tour information pertaining to a plurality at points of interest in a tour, monitoring a power availability of a first of the plurality of mobile client terminals and a current location of a user, presenting the guided tour information on a display of the first mobile client terminal according to the current location, and estimating whether the power availability is sufficient for presenting the guided tour information along the tour or not and instructing accordingly a second of the plurality of mobile client to monitor the current location and to present accordingly the guided tour information on its display.

According to some embodiments of the present invention, there is provided a method of adaptive generating of navigation instructions on a mobile client terminal. The method comprises acquiring, using a mobile client terminal, at least one path passing via a plurality of points of interest, a plurality of access point locations around the at least one path, and guided tour information pertaining to a tour along the at least one path, iteratively monitoring a current location of the mobile client terminal in relation to the at least one path to detect accordingly a deviation from the at least one path, adjusting, locally on the mobile client terminal, the navigation instructions to pass via one of the plurality of access point locations, and automatically connecting to at least one of the plurality of access point locations to download additional guided tour information pertaining to at least one additional point of interest which is passed by while the mobile client terminal being routed according to the adjusted navigation instructions.

According to some embodiments of the present invention, there is provided a method of adaptive coordination of a meeting place between a plurality of users of a plurality of mobile client terminals. The method comprises calculating a plurality of paths having different points of interest and a common meeting place and time, providing each of a plurality of mobile client terminals with navigation instructions to follow another of the plurality of paths, monitoring a current location of each of the plurality of mobile client terminals in relation to a respective the path, identifying at least one deviation of at least one of the plurality of mobile client terminals from a respective the path, calculating at least one of a new meeting place and a new meeting time, and distributing at least one of the new meeting place and the new meeting time to the plurality of mobile client terminals to allow a calculation of a plurality of new paths having the new meeting place as a common meeting place.

Optionally, the calculating is performed according to the deviation.

Optionally, the calculating is performed according to a respective the current location of each of the plurality of mobile client terminals.

According to some embodiments of the present invention, there is provided a system of adaptive generating of navigation instructions on a mobile client terminal. The system comprises a plurality of real time guiding modules each installed in one of a plurality of mobile client terminals and monitors a current location and a power availability thereof and a central unit which calculates at least one path passing via a plurality of points of interest and sends the at least one path and guided tour information pertaining to a tour along the at least one path to a first of the real time guiding modules. The first real time guiding module acquires the at least one path and the guided tour information and presents navigation instructions and the guided tour information to a user of a respective the mobile client terminal according to the current location in relation to a respective the at least one path. Each the real time guiding module performs at least one of controlling hardware of a respective the mobile client terminal, locally adjust the navigation instructions, and adjust the presentation of the guided tour information according to respective the power availability.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data.

Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is schematic illustration of a system of adaptive generating of navigation instructions on a mobile client terminal without requiring a continuous data connection with a remote server, according to some embodiments of the present invention;

FIG. 2 is a flowchart of a method for adaptive generating of navigation instructions on a mobile client terminal for performing a tour, according to some embodiments of the present invention;

FIG. 3 is a flowchart of a process for generating a guided tour data package for a mobile client terminal, according to some embodiments of the present invention; and

FIG. 4 is a method of setting, and automatically updating, a meeting place for a plurality of users of a plurality of mobile client terminals, according to some embodiments of the present invention.

### DESCRIPTION OF EMBODIMENTS OF THE INVENTION

The present invention, in some embodiments thereof, relates to guided tours and, more particularly, but not exclusively, to methods and systems of adaptive generating of navigation instructions on mobile client terminal(s).

According to some embodiments of the present invention, there are methods and systems for presenting to users, in real time, guided tour information about their current location without accessing or with limited access to external sources that require data connection and/or with a limited access to external sources that require data connection, for example without using cellular data services to connect to web service(s).

According to some embodiments of the present invention, there are methods and systems of adaptive generating of guided tour information and/or navigation instructions on a mobile client terminal based on power availability thereof. In such embodiments, the hardware, the presentation of guided tour information, and/or the path according to which the user is navigated may be adjusted to assure that sufficient power source is available to provide a guided tour experience.

According to some embodiments of the present invention, there are methods and systems of splitting a tour managed by a mobile client terminal to a number of sub tours. In these embodiments, a group of users are suggested to split when they are in a proximity to a number of points of interest to instruct different users to visit in different points of interest suitable for their preferences at the same time. Optionally, the sub tours have a common meeting place and time.

According to some embodiments of the present invention, there are methods and systems of sequentially displaying guided tour information on displays of a number of mobile client terminals so as to preserve power availability along a tour with a plurality of points of interest.

According to some embodiments of the present invention, there are methods and systems of identifying, using a mobile client terminal, when a data connection is required in order to download guided tour information and/or navigation instructions, such as maps, and/or upload user content and/or messages and automatically adjusting the path of a guided tour to pass in the coverage area of an access point such as a WLAN access point documented in the memory of a respective mobile client terminal.

According to some embodiments of the present invention, there are methods and systems of adaptive coordination of a meeting place between users of mobile client terminals who tour according to different navigation instructions, for example along different paths and/or in different time frames.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

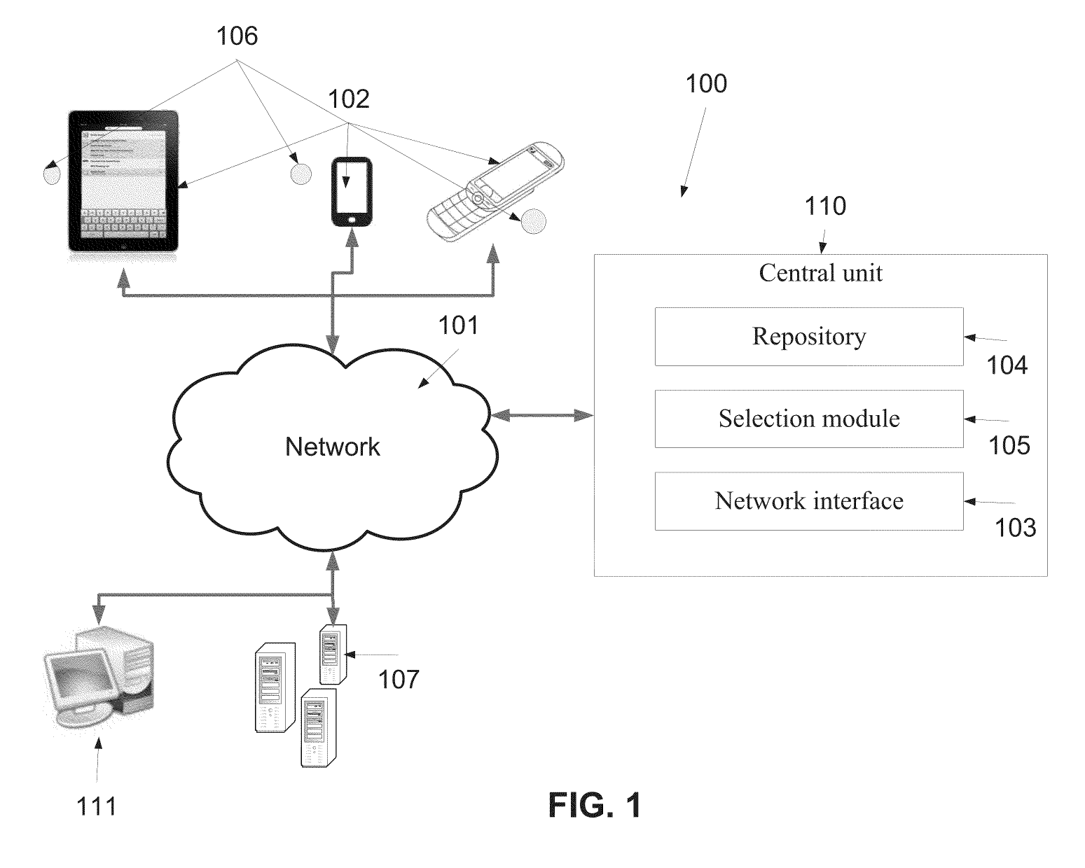

Reference is now made to FIG. 1 is schematic illustration of a system 100 of adaptive generating of navigation instructions on any of a plurality of mobile client terminals 102 without requiring a continuous data connection, according to some embodiments of the present invention. The system 100 optionally includes a central unit 110, for example a network node, which is connected, via a communication network 101, such as the internet, to the plurality of mobile client terminals 102. The central unit 110 provides real time guiding modules 106, which are optionally installed in the mobile client terminals 102, optionally in response to requests which includes user selected point(s) of interest, a guided tour data packages. The guided tour data packages allow each one of the real time guiding modules 106 to navigate and guide a user, or a group of users (for brevity referred to herein as a user), along a tour optionally without further guided tour information.

The guided tour data package optionally includes one or more map segment(s) covering path(s) passing via point(s) of interest, optionally user selected, and guided tour information pertaining to these point(s) of interest. As used herein, guided tour information includes text, video, animation, images, and/or audio files which include descriptive content pertaining to location of one or more points of interest. It should be noted that the system may be adapted for strolling tourists, providing guided tour information, and/or any other individuals or groups, for example sales persons, real estate agents and/or the like.

The system 100 allows mobile client terminals 102 to present navigation instructions and guided tour information in real time, for example to a user while she strolls in a city, a geographical area, and/or in a tourism attraction having a number of points of interest, without accessing external sources that require data connection and/or with a limited access to external sources that require data connection, for example without using cellular data services to connect to web services. As used herein, a mobile client terminal 102 means, a mobile telephone, a Smartphone, a tablet, a laptop, a camera having a network interface and/or the like.

The system 100, which is optionally implemented using one or more network servers, includes a network interface 103, such as network interface card and/or a port. The network interface facilitates the establishing of bidirectional communication between the system 100 and the mobile client terminals 102. This communication allows the system 100 to receive requests indicative of one or more user selected points of interest and to respond with one or more paths which pass via these locations and respective guided tour information, for example as described below.

The system 100 further includes a central unit 110 which includes or connected to a repository 104 for hosting the guided tour information, optionally associated points of interest, for example coordinates thereof, and a selection module 105 which receives the request for guided tour data packages via the network interface 103 and generates according to locations listed in the request the guided tour data packages, for example as described below. The guided tour data packages are optionally forwarded to the mobile client terminals 102 via the network interface 103. It should be noted that the points of interest may be tourist attractions, attractions uploaded by a certain user and/or group admin, and/or locations adapted to a certain type of users, for example sales spots for sales persons and real estate assets for real estate agents. The repository 104 optionally includes guided tour information pertaining to points of interest which are selected for a certain type of tourists, for example holy places for pilgrims, designer's shops for design lovers, soccer related locations for soccer team followers and/or the like. These places may be tagged to facilitate the selection thereof by users.

Optionally, the repository 104 is governed by a digital rights management (DRM) system that manages the rights related to stored content, enabling supervised use of branded content similarly to the known in the art.

Optionally, each mobile client terminal 102 hosts a real time guiding module 106, such as an app, a widget, or an add on, with a user interface, for example a tour graphical user interface (GUI), that manages the presentation of navigation instructions and/or guide tour information. The user interface optionally includes a tour creator GUI which enables the user to create a tour with content suited to his interest by selecting points of interest based on categories, keywords, natural searching within the content database and outside content. The tour GUI and the tour creator GUI are optionally adapted to be displayed on various client terminals, including Smartphones and personal computers. Optionally, the tour creator GUI is managed by a portal which may be accessed in advance using the client's home or office computer, before starting the tour or even arriving at the tour location.

Optionally, a plurality of user profiles, such as subscriber profiles, are stored and managed by the system 100, for example as described below. Optionally, the user profiles are subscriber profiles of a social network, which are managed by a subscriber database, for example managed by separate web servers 107 and/or in a local repository. Each user profile optionally includes preferences and/or characteristics of a user, for example demographic characteristics, usage history and/or references to tours created by the user.

According to some embodiments of the present invention, users may add new points of interest (i.e. adding GPS coordinates) and/or generate guide tour information pertaining to selected points of interest (i.e. adding images, video files, text, fill in reports and/or the like). This user data may be uploaded to the repository 104 and documented in respective records. Optionally, the user defines new paths which pass via certain points of interest.

It should be noted that though the selection module 105 is depicted in the central unit 110, it may be installed locally in any of the mobile client terminals 102.

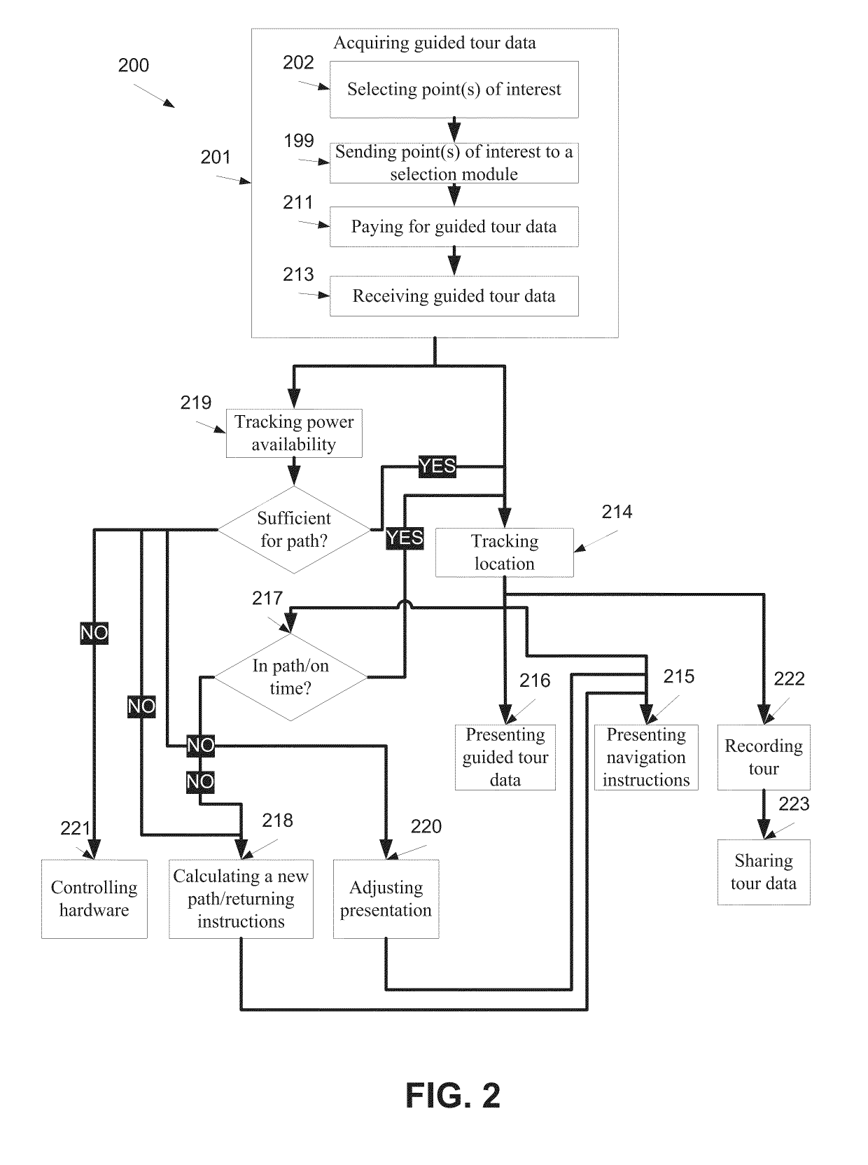

Reference is now also made to FIG. 2, which is a flowchart of a method 200 for adaptive generating of navigation instructions on a mobile client terminal 102 for performing a tour, such as a sightsee pedestrian tour, a real-estate pedestrian tour, and a mailman tour, according to some embodiments of the present invention.

First, as shown at 201, a guided tour data which includes navigational information, such as a plurality of map segments covering one or more paths passing via one or more user selected points of interest and guided tour information pertaining to these user selected points of interest are acquired by the real time guiding module 106. The tours may be calculated for pedestrian(s), a flight passenger, a bus passenger, a train passenger, and/or the like. For example, when used for in-flight touring the user may be presented with a map where she is, show media of the ground a special attractions and/or optionally a layer of AR information.

The guided tour data may be acquired as depicted in some or all of blocks 199, 202, 211, and 213. For example, as shown at 202, the user optionally selects one or more point of interest, for example using a GUI that is presented thereto on the mobile client terminal 102 and/or on any other client terminal that may communicate with the selection module 105, which is optionally located at the central unit 110. As shown at 199, a request message with selected location(s) is sent to the selection module 105. Optionally, the request message includes a starting point of a tour, for example a current location of the user as identified by a navigation module of the client terminal, for example as described below. The paths are optionally calculated according to user preferences, for example allocated time, strolling velocity, average time spent in a venue, and/or the like. It should be noted that the guided tour data may be acquired as depicted in some or all of blocks 199, 202, 211, and 213 using a personal computer 111 or any other terminal, before the user has arrived at the tour area, for example from home and/or office, optionally via a portal or a webpage that allows the user to communicate with the central unit 110.

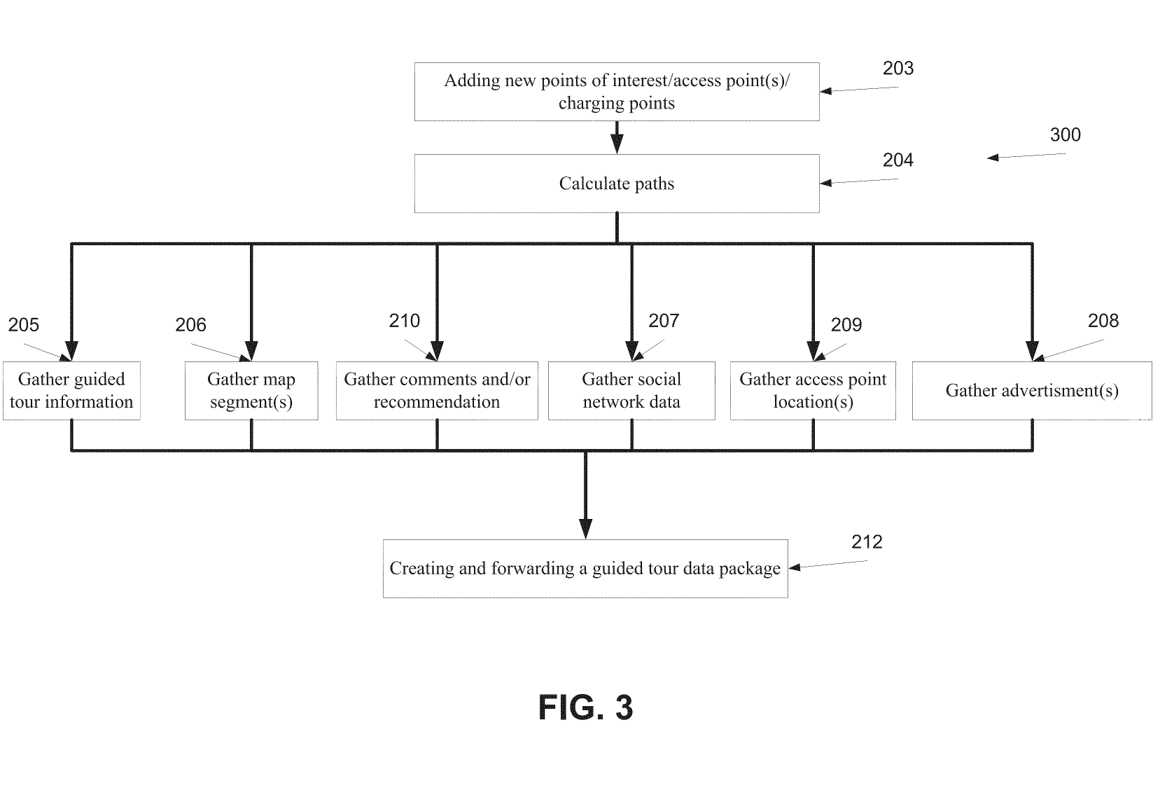

Reference is now also made to FIG. 3, which is a flowchart of a process 300 for generating a guided tour data package, referred to herein as a guided tour data package, according to some embodiments of the present invention. The process is optionally implemented on the selection module 105.

The selection module 105 optionally automatically adds one or more new points of interest along or in proximity to the one or more paths, as shown at 203.

The selection module 105 optionally adjusts the one or more paths to pass via area(s) covered one or more access point locations, such as wireless routers and hotspot, which are available to the client terminal to connect to, for example unsecured wireless local area network (WLAN) router and/or a hotspot of a hotspot service to which the respective client terminal is subscribed.

Now, as shown at 204, the selection module calculates accordingly one or more possible paths which pass via the selected and/or new points of interest. Optionally, the calculation of the path(s) takes into account the time during which the points of interest are available and/or preferred time to visit, for example when less tourists visit the location and/or when a preferred view is available (i.e. during sunset).

Now, as shown at 205, the selection module 105 optionally gathers guided tour information pertaining to any of the points of interest along or in proximity to any of the calculated possible path(s) and/or in a bounding area which encloses some or all of the possible paths is gathered. The bounding area is optionally an area which encloses some or all of the possible paths which go through the user selected locations and/or in proximity thereto. The bounding area may optionally be calculated by simulating a shift of a rectangle or any other shape along each one of the paths to cover a margin of several meters therefrom, for example 10 meters (m), 100 m, 1000 m or any intermediate or larger margin. Optionally, the bounding area is formed by connecting all areas which enclose some or all possible paths and at least a defined margin therefrom. The new points of interest are optionally selected according characteristics and/or preferences of the user, for example as defined in a respective profile.

Optionally, the one or more paths are adjusted to pass via the new points of interest. For example, according to the preferences and optionally according to a dynamic allowed deviation, new points of interest are added, either as predefined locations which appear in the navigation instructions and/or as alerts which appear when the user is in an applicable distance, optionally dynamic, therefrom.

For example, if the user preferences (including setting) do not preclude near-by alerts, the user is alerted every certain period when there are points of interest around him and/or when the points of interest are at the applicable distance therefrom. The alert may specify the distance that is added to the tour and/or time required for visiting the new location and/or the battery percentage required for presenting respective guided tour information. The applicable distance may be adjusted according to the attraction, for example according to the suitability thereof to the user profile, according to the ranking thereof by other users and/or according to any other ranking mechanism.

Optionally, as shown at 206, the selection module 105 optionally selects and gather map segments and/or navigation directions, which are suitable for areas along or in proximity to the one or more paths. The segments and/or instructions are optionally extracted from a respective map and/or directions data in the repository 104.

Optionally, as shown at 207, the selection module 105 gathers social network information pertaining to the points of interest along and/or around the path(s) and/or in proximity to the path(s). For example, the selection module 105 may acquire status lines; images and/or video files recorded by socially connected peers with regard to the points of interest along and/or around the path(s), optionally with respective locational data, such as GPS coordinates. In such an embodiment, the social network information is presented when the user is in a respective location along or in proximity to the path(s).

Optionally, the selection module 105 automatically identifies tours conducted by friends and/or followed entities and suggest the user to combine points of interest in his tour.

Optionally, as shown at 208, the selection module 105 gathers advertisements pertaining to the points of interest along and/or around the path(s) and optionally in proximity to the one or more paths. The advertisements are optionally set to be presented by the real time guiding module 106, for example when the user is in proximity to the advertiser location (i.e. in proximity to a café, a restaurant, a guided tour service provider and/or the like) and/or in a certain time of the day (i.e. restaurants in lunch time and dance bars at night). The advertisements may include coupons for local business which are in proximity to the one or more paths. For example, coupons may be extracted from a local coupon website, such as Groupon™. The advertisements can be part of the tour thus eliminating the necessity for a data connection at the time of delivery of the advertisement or delivered via an ad server when there is a data connection.

Optionally, as shown at 209, the selection module 105 gathers a list with coordinates of one or more access point locations, for example from a respective repository, such as a Wi-Fi-FreeSpot™ Directory.

Optionally, the selection module 105 publishes the path(s) in a social network page, a forum, or any other selected webpage of the user. This allows friends of the user and/or other viewers to add and/or suggest new location on interest to the user. As shown at 210, the selection module 105 may now gather the comments and/or recommendations.

Optionally, some or all of the gathered data, for example some or all of the guide tour information require a payment from the user. Such a payment is optionally managed by a billing server. In such embodiments, the user may select whether she is interested in receiving data for a charge. For example, the user may determine whether she is interested in receiving basic guide tour information for free or more comprehensive tour information for a charge. Now, as shown at 211, the real time guiding module 106 may mange a communication with a billing server and/or any other entity, as commonly known in the art to facilitate the payment for receiving some or all of the gathered data. The purchase may be, for example, in return to debit, credit and/or coupons. The purchase may be, for example, via an app purchase mechanism of a third party, for example through Apple App store, or designated web sites.

Now, as shown at 213, the guided tour data package is received by the real time guiding module 106 of the mobile client terminal 102.

As shown at 212, some or all of the data gathered by the selection module 105 is added to a guided tour data package that is forwarded to the real time guiding module 106, optionally based on payment approval. It should be noted that the aforementioned gathered data may be gathered by the real time guiding module 106. It should be noted that the aforementioned gathered data may be forwarded to the real time guiding module 106 not in a data package but as a number of transmissions which are collectively referred to herein as a data package.

In use, as shown at 214, the location of the mobile client terminal 105 (namely the user) is tracked, for example using a navigation module that is integrated into the respective client terminal, such as a global positioning system (GPS) module or an assisted (A-GPS) module. As used herein, navigation module may include non GPS navigation modules, such as radio frequency identification (RFID) modules, accelerometers and/or gyroscopes for closed space navigation.

This allows, as shown at 215, presenting to the user instructions indicative of how to follow one of the paths defined in the received guided tour data. The presentation may include visual instructions, visual instructions on a displayed map, visual instructions on an artificial reality (AR) view, audible instructions which are presented using the speakers of the mobile client terminal, tactile instruction which are presented using the vibrating elements of the mobile client terminal 102 and/or the like.

As shown at 216, the mobile client terminal presents to a user of the mobile client terminal, according to her location, at least matching guided tour information from the guided tour data package. Additionally or alternatively, when the user goes by a point of interest, she is presented with a notification offering the user to purchase the additional guided tour information pertaining to her location. The purchase may be by entering a code, using a credit, and/or establishing communication with a billing server. Only after the purchase is settled, the guided tour information is presented.

Other gathered data, for example advertisements and social network data, may respectively be presented according to the location of the user. As the routing guided tour data is received in advance, the mobile client terminal does not have to establish data connections while the user takes the tour as all the data has been downloaded, for example as a guided tour data package, for example as described above.

As shown at 217, the real time guiding module 106 verifies that the user is on the path and/or on time and if she is not along the path and/or on time the real time guiding module 106 calculates instructions which direct the user to the path and/or to the nearest point of interest, as shown at 218. Optionally, if returning to the path and/or the nearest point of interest is currently more remote than a certain distance, optionally predefined, a new path is selected from the received paths and/or calculated according to the current location of the user. Optionally, if returning to the path and/or to the nearest point of interest does not allow overcoming a delay, optionally predefined, a new path is selected from the received paths and/or calculated according to the current location of the user, for example skipping one or more points of interest. As shown at 218, the real time guiding module 106 calculates an optimized new path optionally based on the user choosing whether she wishes to visit all the points of interest or not.

Optionally, as shown at 219, the real time guiding module 106 monitors the power availability of mobile client terminal 102, optionally iteratively, continuously, and/or according to outputs of the power source, for example the battery of the mobile client terminal 102. The power availability may be evaluated based on power sources, which are currently connected and/or not connected to the client terminal 102, for example energizing batteries and/or spare batteries. The power availability is optionally calculated based on the planned tour. For example, the real time guiding module 106 calculates the power availability by summing the energy required for presenting the guiding tour information in each one of the points of interest along the selected path, estimated general usage consumption, and/or estimated navigation usage consumption. Optionally, points are used for calculating power availability where a certain number of points are available to begin with. For example, each point of interest of the tour, as well as any other guiding or navigation tasks, may be pointed according to estimated battery consumption. For example, one point is allocated per each minute of navigation using the navigation module, three points are allocated per each minute of playing a video clip, four points are allocated per each minute of participating in a telephone call, and/or one point is allocated call initiation. Additionally or alternatively, power availability may be calculated in real time based on output of a power unit. Additionally or alternatively, power availability may be calculated after power consuming events, such as a phone call and a presentation of a video clip. Optionally, the rate of power usage is monitored. If the rate is higher or lower than expected, the prediction re power availability may be updated and so does the selected tour path. Optionally, the calculation is adjusted according to usage history of the user. Optionally, the calculation is adjusted according to usage history of users traveling in the respective points of interest.

Additionally or alternatively, power availability may be calculated in real time based on a number of mobile client terminals 102 which may manage the tour. In such an embodiment, for example when a number of real time guiding module 106 receive an indication that they share a common tour, the power availability is based on a combination of all the power sources. In such an embodiment, a guided tour data package may be uploaded to all the mobile client terminals 102 and/or transferred from one to another using a wireless personal area network (WPAN) connection, such as a Bluetooth™ connection. A notice about a switch in the mobile client terminal 102 which should manage the tour is presented to the user in advance. In some embodiments, a number of mobile client terminals 102 works simultaneously where each is activated for a different task. For example, while one is used for presenting media files, the other is used for navigation. Optionally, a user instructs the switch. Optionally a code or a token is generated to ensure that simultaneous execution of the system is limited to a number of approved licenses.

This allows, as shown at 218, to calculate a new path and to provide navigation instructions, accordingly. For example, the path is adjusted to pass via a charging location, such as a café, a respective hotel, and/or the like for power and/or battery charging. Optionally, the navigation instructions are set so that the tour, which is set for the user, is shortened to make sure the user arrives to the charging location with enough battery power. Optionally, the points of interest are divided to a number of groups, optionally two, so that the battery power suffices to allow the user to visit all the members in one group and the members of the other group after visiting the charging location. Optionally, the charging period is taken into account, for example according to the model/type of the mobile client terminal 102 and/or charging history.

Optionally, as shown at 220, the presentation of guided tour information is adjusted according to the power availability. For example, video files may not be presented, brightness resolution and/or volume are restricted, and/or the like if the power availability is low. Optionally, guided tour information records and/or data type are ranked according to their importance for the guided tour experience. In such embodiments, low ranked information may be skipped when the power availability is somehow low, medium ranked information may be skipped when the power availability is low, and highly ranked information may be skipped when the power availability is extremely low.

Optionally, as shown at 221, hardware of the mobile client terminal 102 is controlled according the power availability. For example, power consuming elements such as navigation modules, are shutdown or operated interchangeably when the mobile client terminal 102 is inside a closed space, such as a Museum. The power consuming elements may be re-opened after a certain period, in response to a location check after a certain period, such as 10 minutes, when exiting the museum and/or the like.

Optionally, as shown at 222, actual tour details are recorded, for example the actual placed visited by the user, the time spent, and the optionally the media recorded, for example as described below. This allows, as shown at 223, sharing information about the actual tour with friends, for example by uploading tour data and/or a derivative thereof to social network webpage and/or the like. For example, the coordinates of the tour are recorded so as to be presented on a map, where photos, videos, and notes taken during the tour are loaded as interactive symbols in the map. This interactive map may now be uploaded. For example, the Interactive map responds when a location is rolled over or pressed and the personal media (i.e. photos, notes, and video clips) related to that location on the map is presented. In such embodiments, the tour previously presented by friends may be selected to be performed by a user. In such an embodiment, the path(s) are optionally set according to an uploaded tour. In another embodiment, the tour details may be coordinated with selected and dated images text and/or video files to allow automatic generation of an album or a folder wherein each image text and/or video files is tagged with information pertaining to a respective recording venue and/or tour. The album may be posted in a social network. In another embodiment, the tour details may be coordinated with selected and dated images to automatically set privacy rules on images, text and/or video files based on the location at which they where took. For example, images taken in public points of interest are set as public and images taken in private points of interest are set as private, for example hotel room and/or a house of friends and not shared.

When the current location of the user is at the endpoint of the tour, the user may be alerted that she has come to the edge of his tour suggest to the next tour which is available either locally or remotely. If the next tour is not locally available the user may be directed toward a hotspot.

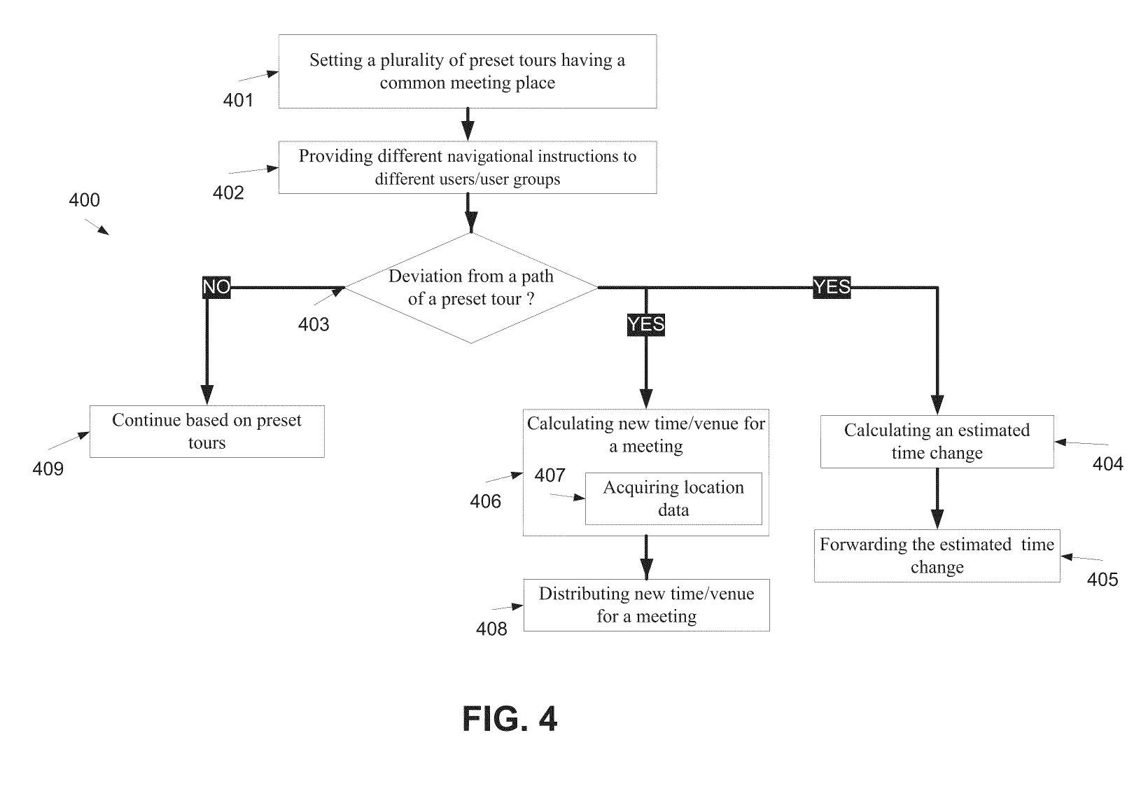

Reference is now also made to FIG. 4, which is a method 400 of setting, and automatically updating, a meeting place for a plurality of users of the plurality of mobile client terminals 102 wherein at least two of the users are instructed by respective mobile client terminals 102 to conduct different tours, for example as described above, according to some embodiments of the present invention.

First, as shown at 401, different preset tours are set to users of a certain group based on different preferences and/or user selections. The preset tours may be tours as described above or only a time spot during which the user location is monitored, for example while the user shops or rests. The preset tours are set so that users are instructed to be in a common meeting place in or about a certain time. The preset tours are optionally sub tours, splits, of a tour set for a group. In such an embodiment, a tour managed by one real time guiding module 106 is split with other real time guiding module(s) 106. The split may be managed by the central unit 110 and/or any of the one real time guiding modules 106. Preset tours may be set to synchronize a plurality of mobile client terminals 102 on the same tour that is managed in different times. In such a manner, a certain group which starts the tour at a certain hour is instructed to meet another group which starts the tour at a later hour and instructed to spend less time in the points of interest and/or visit less points of interest.

Additionally or alternatively, the preset tours may be set to synchronize a plurality of mobile client terminals 102 such that multiple users on the same tour visit a plurality of different locations while location thereof is tracked and they are navigated to a meeting point on the tour at a common time. In such a manner, different members of the tour can divide their time differently among the tour's locations.

In use, users may input their preferences and/or characteristics while setting the tour, for example using a GUI as described above. In such embodiments, splitting a tour among user may be suggested dynamically, for example when the preferences and/or characteristics of users indicate that different locations of interest should be visited by different users of sub groups of users. For example if Alex, Cindy and Mia are set as users of who are designated with a tour to Rome and Alex set likes old cars and Cindy and Mia set that they like Modern art, the tour real time guiding tour may suggest a split where one preset tour directs Alex to an old car exhibit show which is held in town and another preset tour directs Cindy and Mia to the National Gallery of Modern Art in Rome.

Now, as shown at 402, navigation instructions are provided. While one mobile client terminal 102 provides navigation instructions for one preset tour, another mobile client terminal 102 provides navigation instructions for another. As shown at 403, each one of the mobile client terminal 102 monitors whether the respective user deviated from the path(s) of the preset tour, for example exceeded predefined boundaries which are set around the one or more oaths which are set for the tour, for example as described above. As shown at 409, as long as no deviation and/or a minimal deviation is detected, navigation instructions are given based on the preset tours. However, if a deviation is detected, as shown at 404, an estimated change in the arrival of the user to the meeting place, for example an estimated delay, may be calculated. As shown at 405, the estimated delay and/or the coordinates of the user are optionally forwarded to the central unit 110 and/or directly to mobile client terminals 102, for example to the real time guiding modules 106, for example via peer to peer communication. Additionally or alternatively, as shown at 406, a new meeting time and/or venue, may be calculate according to the deviation and/or the estimated time change, either by the central unit 110, the mobile client terminal 102 of the delayed users and/or by the mobile client terminals 102, for example mobile client terminals 102 which receive a notification pertaining to the estimated time change. The new meeting time and/or venue are optionally calculated based on information pertaining to locational data of each one of the mobile client terminals 102 who runs a preset tour and/or an adjusted preset tour. The mobile client terminals 102 may provide the locational data either iteratively, for example using SMS, upon request, which may be sent using an SMS, whenever a WLAN connection is established, for example using or an hypertext transfer protocol (HTTP) message, and/or continuously using a data connection, as shown at 407.

As shown at 408, the new meeting place and/or venue are distributed among the mobile client terminals 102. Optionally, a confirmation is required from each one of the mobile client terminals 102 before the distribution of the new meeting place and/or venue.

It is expected that during the life of a patent maturing from this application many relevant systems and methods will be developed and the scope of the term mobile client terminal, a module, a network, a central unit, and a navigation unit is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of adaptive generating of navigation instructions on a mobile client terminal, comprising:
acquiring, using a mobile client terminal, at least one path passing via a plurality of points of interest and guided tour information pertaining to a tour along said at least one path;
monitoring power availability and a current location of said mobile client terminal;
presenting navigation instructions to a user of said mobile client terminal according to said current location in relation to said at least one path;
presenting said guided tour information to said user according to said current location; and
updating at least one of said navigation instructions and a presentation of said guided tour information according to said power availability.

2. The method of claim 1, wherein said navigation instructions allows instructing said user along said at least one path without requiring a data connection with a remote server.

3. The method of claim 1, wherein said updating comprises:
calculating, locally on said mobile client terminal, a new path passing via at least one of said plurality of points of interest so that said power availability is sufficient for presenting a portion of said guided tour information pertaining to said at least one point of interest; and
presenting navigation instructions to a user using said mobile client terminal according to said new path.

4. The method of claim 1, wherein said acquiring comprises acquiring a plurality of map segments enclosing and depicting said at least one path; wherein said presenting navigation instructions comprises presenting at least part of at least one of said plurality of map segments to said user of said mobile client terminal according to said current location in relation to said at least one path.

5. The method of claim 1, wherein said acquiring comprises acquiring from said user at least one of said plurality of points of interest and sending said at least one user selected point of interest to a network node via a network to allow said network node to calculate said at least one path.

6. The method of claim 5, wherein said network node adds at least one new point of interest to said plurality of points of interest, said at least one new point being selected according to at least one tour conducted by another user.

7. The method of claim 6, wherein said user and said additional user are socially connected to one another.

8. The method of claim 5, wherein said network node adds at least one new point of interest to said plurality of points of interest according to social media data pertaining to at least one additional user which is socially connected to said user.

9. The method of claim 1, wherein said at least one path is calculated to pass in an area covered by at least one access point; further comprising instructing said mobile client terminal to automatically establish a wireless connection with said at least one access point to at least one of download an update to said at least one path, download an update to said guided tour information, and to upload data acquired during said presenting.

10. The method of claim 1, wherein said acquiring comprises acquiring at least one advertisement having a location tag; further comprising presenting said at least one advertisement according to a match between said current location and said location tag.

11. The method of claim 5, wherein said advertisement is a location based coupon selected according to said current location.

12. The method of claim 1, further comprising presenting guided tour information pertaining to some of said plurality of points of interest only when said current location is in proximity thereto.

13. The method of claim 1, wherein said presenting said guided tour information comprises presenting a purchase offer according to said current location and suspending the presentation of said guided tour information until said user approves said purchase offer.

14. The method of claim 5, further comprising providing at least one of preferences and characteristics of said user; wherein said network node adds at least one new point of interest to said plurality of points of interest according to at least one of said preferences and said characteristics.

15. The method of claim 1, further comprising recording said location as long as said user perform said tour so as to create a tour log and sharing said tour log with a plurality of other users.

16. The method of claim 1, further comprising controlling at least one hardware component of said mobile client terminal according to said power availability.

17. The method of claim 1, wherein acquiring comprises acquiring a plurality of access point locations in proximity to said at least one path; further comprising adjusting said navigation instructions to instruct a user to pass via one of said plurality of access point locations.

18. The method of claim 1, further comprising billing said user for at least some of said guided tour information.

19. The method of claim 1, wherein said updating comprises setting instructing another mobile client terminal to perform said presentation.

20. The method of claim 1, wherein said updating comprises setting instructing to another mobile client terminal to perform said presentation.

21. A computer readable medium comprising computer executable instructions adapted to perform the method of claim 1.

22. A method of splitting a tour managed by a mobile client terminal, comprising:
providing a plurality of preferences each of another of a plurality of tour participants;
uploading to a mobile client terminal guided tour information pertaining to a plurality at points of interest in a tour navigated using said mobile client terminal;
monitoring a current location of said mobile client terminal;
calculating a plurality of navigation instructions sets each for another of a plurality of sub tours, each said sub tour passes via another of said plurality at points of interest, said another point of interest being selected according to respective said preferences of one of said plurality of tour participants and a proximity to said current location; and
outputting said plurality of navigation instructions sets.

23. The method of claim 22, wherein at least one of said navigation instructions sets is forwarded to another mobile client terminal.

24. A method of sharing the display of guided tour information, comprising:
installing on a plurality of mobile client terminals guided tour information pertaining to a plurality at points of interest in a tour;
monitoring a power availability of a first of said plurality of mobile client terminals and a current location of a user;
presenting said guided tour information on a display of said first mobile client terminal according to said current location; and
estimating whether said power availability is sufficient for presenting said guided tour information along said tour or not and instructing accordingly a second of said plurality of mobile client to monitor said current location and to present accordingly said guided tour information on its display.

25. A method of adaptive generating of navigation instructions on a mobile client terminal, comprising:
acquiring, using a mobile client terminal, at least one path passing via a plurality of points of interest, a plurality of access point locations around said at least one path, and guided tour information pertaining to a tour along said at least one path;
iteratively monitoring a current location of said mobile client terminal in relation to said at least one path to detect accordingly a deviation from said at least one path;
adjusting, locally on said mobile client terminal, said navigation instructions to pass via one of said plurality of access point locations; and
automatically connecting to at least one of said plurality of access point locations to download additional guided tour information pertaining to at least one additional point of interest which is passed by while said mobile client terminal being routed according to said adjusted navigation instructions.

26. A method of adaptive coordination of a meeting place between a plurality of users of a plurality of mobile client terminals, comprising:
calculating a plurality of paths having different points of interest and a common meeting place and time;
providing each of a plurality of mobile client terminals with navigation instructions to follow another of said plurality of paths;
monitoring a current location of each of said plurality of mobile client terminals in relation to a respective said path;
identifying at least one deviation of at least one of said plurality of mobile client terminals from a respective said path;
calculating at least one of a new meeting place and a new meeting time; and
distributing at least one of said new meeting place and said new meeting time to said plurality of mobile client terminals to allow a calculation of a plurality of new paths having said new meeting place as a common meeting place.

27. The method of claim 26, wherein said calculating is performed according to said deviation.

28. The method of claim 26, wherein said calculating is performed according to a respective said current location of each of said plurality of mobile client terminals.

29. A system of adaptive generating of navigation instructions on a mobile client terminal, comprising:
a plurality of real time guiding modules each installed in one of a plurality of mobile client terminals and monitors a current location and a power availability thereof;
a central unit which calculates at least one path passing via a plurality of points of interest and sends said at least one path and guided tour information pertaining to a tour along said at least one path to a first of said real time guiding modules;
wherein said first real time guiding module acquires said at least one path and said guided tour information and presents navigation instructions and said guided tour information to a user of a respective said mobile client terminal according to said current location in relation to a respective said at least one path; and
wherein each said real time guiding module performs at least one of controlling hardware of a respective said mobile client terminal, locally adjust said navigation instructions, and adjust the presentation of said guided tour information according to respective said power availability.
